(19) United States
(12) Patent Application Publication
(10) Pub. No.: US 2018/0271123 A1
(43) Pub. Date: Sep. 27, 2018

(54) High protein meal and flour compositions and methods

(71) Applicant: Daniel Tegel, Wildwood, MO (US)

(72) Inventor: Daniel Tegel, Wildwood, MO (US)

(21) Appl. No.: 16/000,182

(22) Filed: Jun. 5, 2018

Related U.S. Application Data
(63) Continuation of application No. 14/376,044, filed on Jul. 31, 2014.
(60) Provisional application No. 61/695,855, filed on Aug. 31, 2012.

(51) Int. Cl. A23L 7/10; B02C 21/00; B02C 9/04; A23L 25/00; A23G 9/38; A23G 1/44; A21D 13/064; A21D 13/04; A21D 2/36; A21D 2/26; A21D 2/18; A21D 13/047; A21D 13/40; A23L 11/00; A23L 19/15

(52) U.S. Cl. CPC A23L 7/10; A23V 2200/264; A23L 7/198; B02C 9/04; A23L 25/30; A23G 9/38; A23G 1/44; A21D 13/064; A21D 13/04; A21D 2/366; A21D 2/364; A21D 2/266; A21D 2/186; A21D 2/183; A21D 13/047; A21D 13/40; A23L 11/00; A23L 19/15; A23L 11/05; A23V 2002/00; B02C 21/00

(57) ABSTRACT

This invention pertains to the development of a high protein oil seed flour as a replacement for both wheat based and gluten free flours used in baked, dry and liquid goods which optimizes nutrition. The seed flour is based on the novel use of processing sunflower and other oil type seeds into a flour, meal, or protein isolate to replace a significant portion of traditional and gluten free flours in food goods, including baked, dry and liquid goods. The invention provides composition formulas that significantly optimize and improve the overall nutritional value of processed foods by balancing proteins and carbohydrates through an optimized ratio of seed to grain or tuber flour. The composition formulas also increase the absolute values of protein in processed foods to achieve recommended daily allowances as well as provides for increase satiety, improve blood sugar balance, weight management, and health.

### CROSS-REFERENCE TO RELATED APPLICATIONS

The instant application is a PCT International Application based on and claims the benefit of priority of U.S. provisional application No. 61/695,855, filed Aug. 31, 2012, the disclosure of which is hereby expressly incorporated by reference hereto in its entirety.

### TECHNICAL FIELD

The field of art to which this invention pertains is meal and flour and methods of making the same.

### BACKGROUND

Traditional wheat based and gluten free flours are typically high in carbohydrates and relatively low in protein, which rapidly elevates blood sugar levels and increases insulin reactivity during the digestion process. The prolonged and repeated response of high blood sugar levels and insulin reactivity is often linked to weight gain, obesity, and diabetes, which are growing rampantly in the United States. Over 30% of the United States is now considered obese and approximately 8% of the US population in some stage of diabetes, contributing to heart disease, hypertension, nervous system problems and many more secondary physical issues.

The traditional process for producing many flours, relies on over-processing the grain, stripping away the bran and germ which contains important nutrients necessary for supporting health. Wheat based products have attempted to partially correct this problem by fortifying flours with vitamins and minerals, although they are still deficient compared to the whole grain sources from which they originated.

Gluten free flours have even less nutrients than their wheat counterpart products, as they lack the protein that gluten carries, and have not been fortified. The lack of gluten protein in gluten free products has left most gluten free products to be less desirable in taste and texture than wheat based products as the gluten protein creates elasticity. Many gluten free products are often crumbly, dry and have less texture and taste, due to the missing gluten protein.

Populations who are restricted to gluten free diets, such as celiacs, those who have wheat sensitivities, and over 55 other disease states related to the ingestion of gluten, are restricted to diets that are more nutrient deficient than those who have access to wheat based diets. The gluten free community, which approximates 40 million people in the US, are often consuming a high carbohydrate, high glycemic food that spikes blood sugar levels, when they eat gluten free processed foods lacking in micronutrients. Although inflammation in the intestines maybe reduced from strict adherence to a gluten free diet, the tradeoff is new set of problems related to the triggering of insulin sensitivity due to frequent ingestion of high carbohydrate foods. Eating gluten free does not mean that one is eating healthy.

Besides those who have wheat sensitivities, there are others who have food allergies to rice or nuts. For those who have food allergies to nuts, wheat, rice or other gluten free alternatives, there are food choices are even more limited. The frequent and repeated ingestion of any grain or tuber food, can lead to a food sensitivity. Particularly, with those who already have compromised intestinal lining and immune systems, switching from the frequent ingestion of wheat to the frequent ingestion of rice or other gluten free flours, can eventually lead to a sensitivity with that new flour. Anecdotally, the numbers of those on gluten free diets discovering they have later become sensitive to rice, is increasing.

Diabetics also have difficulty with flour based product choices, as traditional and gluten free flours have a high glycemic load.

There are optimal ratios of carbohydrates to protein that minimize the blood sugar glucose response, therefore prolonging satiety and reducing weight retention, as well as mitigating the risk of diabetes. A ratio of 1-2:1 range for carbohydrates to proteins is optimal, with a 1:1 ratio of carbohydrates being ideal. Maintaining the proper carbohydrate to protein ratio, as well as having the recommended daily amount of protein spread throughout the day, is proven to reduce hunger and help with managing a healthy weight.

Breakfast is one of the most critical meals to have the proper balance of protein to carbohydrates to keep the hunger process in check. Having a high carbohydrate/low protein breakfast triggers an accelerated hunger response and the desire to take in more calories through snacking, consequently leading to more weight gain. Most breakfast offerings do not meet this carbohydrate/protein ratio, nor do they meet the recommended daily allowances of a 15 gram minimum for protein.

The multitude of low protein, high carbohydrate, nutrient deficient baked, dry and liquid good offerings, is contributory to the US epidemic of obesity and diabetes.

Most processed foods, are designed to meet taste and cost objectives, with much less attention to proper nutritional offerings. Most food development focuses on improving structure, taste, manufacturing ease, and cost of food, with little attention to nutritional objectives. Processed foods today, are often over saturated with sugar, use highly processed, genetically modified, and chemically treated flours, that may be addictive in taste, but seldom deliver the nutrition required to meet daily requirements established by the USDA.

### BRIEF SUMMARY OF THE INVENTION

A composition is described comprising a nutrient dense flour or meal made from seeds, nuts, legumes, and/or seed or nut protein isolates or concentrates. Embodiments of the invention include the flour or meal being mixed with grain and/or tuber flour; the flour or meal containing up to 100% seed, nut, legume, and/or seed or nut protein isolate or concentrate flour; the seeds, isolates or concentrates being oil seeds; the oil seeds being sunflower, pumpkin, flax, chia, and/or hemp seeds; the sunflower seeds being Sun Opta SL80 hybrid seeds; the nuts, isolates or concentrates being almonds, cashews, hazelnuts, pistachios and/or peanuts; the legumes being alfalfa, clover, peas, beans, lentils, lupins, mesquite, carob, and/or soy; the grain being wheat, rye, barley, rice, sorghum, teff, kamut, millet, quinoa, corn, starch, and/or amaranth; and the tuber being tapioca, manioc, potato, sweet potato and/or arrowroot.

Also described is a method of making a nutrient dense flour or meal comprising milling seeds, nuts, legumes, and/or seed or nut protein isolates or concentrates. Embodiments of the invention include the seeds, nuts, legumes, and/or seed or nut protein isolates or concentrates being defatted or dehydrated prior to milling; the flour or meal being mixed with grain or tuber flour after milling; the seed, nut, legume, and/or seed or nut protein isolate or concentrate flour being present in an amount up to 100%; the seeds, isolates or concentrates being oil seeds; the oil seeds being sunflower, pumpkin, flax, chia, and/or hemp seeds; the nuts, isolates or concentrates being almonds, cashews, hazelnuts, pistachios and/or peanuts; the legumes being alfalfa, clover, peas, beans, lentils, lupins, mesquite, carob, and/or soy; the grain being wheat, rye, barley, rice, sorghum, teff, kamut, millet, quinoa, corn, starch, and/or amaranth; the tuber being tapioca, manioc, potato, sweet potato and/or arrowroot; and the milling being micro-milling.

These, and additional embodiments, will be apparent from the following descriptions.

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

The present invention provides for the development of a nutrient dense flour made primarily, but not exclusively, from sunflower and pumpkin seeds. Sunflower seeds have the highest protein content of all common seeds and nuts and are ranked as the top superfood in the seeds and nuts score on the ANDI scale (Aggregate Nutritional Density Index). Oil seeds in general, are higher in protein and have an overall more balanced protein to carbohydrate ratio compared to wheat or gluten free flours, leading to more moderate blood sugar glucose response and longer satiety. Seeds also have more healthy fats and fiber than traditional grains or tubers, leading to a more moderate blood sugar response and longer satiety. Sunflower seeds and pumpkin seeds also have the lowest inflammation rating, compared to other seeds, nuts, as well as grain and gluten free flours.

Sunflower seeds and pumpkin seed flour although nutrient rich, are not easily converted into flour form because of their high oil content, which causes production problems (clogging mills or product turning into a paste). This invention uses a plurality of milling processes that are substantively different than conventional milling practices for converting grains or seeds into flours. Additionally, it is discovered that if the seeds are defatted with an extrusion press or super critical cooling process prior to milling, then the seeds can more easily be converted into flour form with less calories. Other oil extraction processes often use chemicals (hexane), leaving a toxic residual or use a high friction process, causing the seeds to overheat and lose their micronutrient value. Overly processed seeds also harden the fractured seed particles, making them difficult to use in processed foods. For an embodiment of this invention, the seeds are milled from 20-100 mesh size using micro mills or other specialized milling equipment for seed meal/flour product; and a cold press extrusion or super critical cooling process is used for removing up to 95% of the oil. For example, defatted seed meal typically removes about 60% of the oil content at this stage of discovery. However, higher fat removal can harden the particles, making it difficult to reuse. The defatted seed meal is then milled into 20-100 mesh size. Seeds are also dehydrated and/or freeze dried to remove moisture prior to milling. Additionally oil seeds can be converted into protein isolates or concentrates, which may reduce the seed content in a formula and increase traditional grain or gluten free flours, yet increase overall protein yield in a formula.

This invention embodies composite blends of oil seed flours, made of sunflower seeds, pumpkin seeds, flax seeds, chia seeds, and hemp seeds.

The invention also provides composition formulae that balance the ratio of seed and nut flour to grain flour for improving both the functional and nutritional quality of food. Too much seed flour and the product has a strong, bitter taste and has binding and baking problems. Too little use of seed or nut flour, and the nutritional benefits as well as structure is missing. Given the hydrophobic nature of most seeds and nuts due to their high oil content, they need to be combined with the proper amount of traditional grain or gluten free and tuber flours to bind well. The proper proportioning of seed flour to traditional or gluten free flours, provides the protein that gluten free flours are missing, giving the food more structure and flavor. The optimum composition ranges from 33-100% seed or nut flour to 0-67% traditional or gluten free flour, depending on the product application. The actual amount selected is based on the product being formulated. For example, for bakery products 66% seed meal and 33% flour and starch has been found to work well. Cookies can be done at 100% seed flour with no flour or starch. There are many product variations. These composition ratios target minimum recommended protein targets of 15 grams for a meal or 10 grains for a snack, with a ratio of 1-2 carbohydrates to 1 protein.

This invention applies the seed flour and composition ratios as a partial or full replacement for all forms of flour and dairy based products. Composition ratios are applied to baked goods, cereals, pastas, crackers, snack bars, chocolates, and other shelf stable products as well as non-dairy milk products.

The general purpose of this invention is to provide healthy eating options in a multitude of processed food categories. It is recognized among many leading physicians, nutritionists and food policy executives that current US dietary habits and food choices are a primary cause of obesity, diabetes, and systemic inflammation. It is also recognized by progressive health professionals that healthier dietary life styles can reverse disease and support prolonged, healthy living. One of the common principles for a improving and sustaining health, is that each meal should have a balance of protein, carbohydrates, fat and fiber to mitigate hunger, blood sugar insulin spikes, and weight gain. The common recommendations based on research is that protein and carbohydrates should range from a 1:1 to 1:2 ratio, with the ideal being 1:1. Additionally, individuals should average 0.8 g of protein/Pound of body weight per day, equally distributed through out the day, which is a minimum of 15 g/meal for the average 150 lb person. There is also agreement among USDA policy executives and nutrition based health practitioners, that there should be a minimum of 6 grams of fiber to support satiety. Healthy fats also support satiety, with the recommendation that approximately 60 grams of healthy fat be ingested daily to support satiety, and organ health. The embodiment of this invention is to provide minimally processed and natural foods alternatives that match optimal nutritional requirements: Protein to Carbohydrate ratios of 1:1-2; Fiber compliment of a 6 grams per serving, and healthy fat ranging from 10-20 grams/serving.

This invention is principled in the concept of designing foods that will meet nutritional targets and support optimal health. This is a diversion from the food industry model that strives to create inexpensive food that people will crave eating, with health considerations being regulated to minimum levels. It is also known that people will not eat foods, no matter how healthy it is, if the food is not acceptable in taste. This invention creates and combines ingredients that are not only good for people, but taste as good or better than products that are entirely grain or tuber based.

Converting seeds and nuts into a flour replacement is an ideal solution for achieving optimal nutritional levels for protein and blood sugar metabolism, as seeds and nuts are already perfectly balanced with a 1:1 protein-carbohydrate ratio. Seeds and nuts also have 2-5 times more protein than traditional and gluten flours. Also, various oil seeds provide healthy sources of fat, rich in Omega 3, Omega 6 and Vitamin E, that are difficult to get from other food sources. Seeds and nuts are also higher in fiber and anti-oxidants compared to wheat or gluten free flours. Progressive health practitioners recommend having seeds and nuts as a core ingredient in a healthy diet, recommending 3-4 ounces per day as a meat substitute. Using seeds and nuts as a flour and other base ingredients is a novel way to increase plant protein and micronutrients intake as well as a way to moderate the blood sugar glucose response. Research also shows that the increased consumption of seeds and nuts leads to weight loss and overall lower BMI (Body mass index). Although seeds and nuts have a higher content of fat than traditional grain, current research shows that the fat in seeds and nuts is preserved in the cell wall of the seed or nut during digestion and either absorbed more slowly than standard fats or is excreted. Consequently, there are approximately 20% less calories that are being converted to energy, than reported on nutritional labeling, meaning that seeds and nuts may have a lower fat content than report through traditional standards for nutritional labeling.

The embodiment of this invention encompasses a plurality of seeds and nuts which are either blended together to combine the unique nutritional properties of each seed or nut into a composite seed meal or flour; or uses an individual seed or nut to increase the nutrition properties, product structure and taste, or economic potential of that individual seed or nut.

For this invention, seed meal or flour refers to seeds that have been ground or milled into fine particles (e.g., micro milled), primarily in the 20-60 mesh range. These flours retain their full fat content and are approximately, by weight, 25% protein and 50% fat, with 10% variance for each number. Seed meals or flours are also defined as seeds that have been defatted and milled into 20-100 mesh size. Defatted seed meals or flours have approximately 35% protein and 25% fat, with a fat variance of 50% depending on how much fat is removed (the balance is typically carbohydrate, e.g., 40%, and fiber). The defatting process can remove a range of fat from the seed flour from 50% to 95% depending on the process and end use. Seed flour could be 10%, 20% 30%, 40%, 50% fat. Preferred applications remove 50-60% fat. Seed flour also refers to oil seed protein isolates or concentrates in which seeds have been defatted and then further processed through filtration, leaving a product that is 90% protein, and no fat, with a 30% variance, i.e., protein would vary down to 60%.

Composite seed meals or flours consist of, but are not exclusive to, sunflower seeds, pumpkin seeds, flax seeds, chia seeds, and hemp seeds, with each seed being used from 0-100% in the seed flour composition, based on the objective of the product application. The following is a list of ratio applications for creating a composite seed flour: Sunflower seeds (0-100%), have the highest protein content, mildest flavor and is the most economical; pumpkin seeds (0-100%) have the best amino acid profile, being high in tryptophtophan and lysine for muscle relaxation and digestive support: chia seeds (0-50%) have the best Omega 3:6 ratios and content and are hydrophilic helping with product binding; flax seed (0-50%) has the highest lignin count and also good source for Omega 3 and 6; and hemp seed (0-75%) has best source of fatty acids and good Omega 3:6 profile, as well as has a complete amino acid chain. All are high in protein and have approximately a 1:1 ratio of protein to carbohydrate. Composite seed flours compliment the amino acid profile of one another, providing a complete amino acid profile to improve the digestion of protein. Additionally, each seed has it's own distinct flavor, with some having too strong of a taste to use in high ratio of seed to grain or tuber flours. Formula compositions will be discussed in more detail below, but as a general principle the optimum ratios for product development and nutritional balance is that a product should have a ratio of 50-95% seed flours to 5-50% grain or tuber flours.

The preferred blend depends on the product application. Many products work well with 66% seed meal to 33% flour and starch, by weight. Some products, like some cookies, require no traditional flour and can be done at 100% seed meal with 0% flour or starch. Blending a composite flour of different seeds based on the product objective, mitigates the individual distinct flavor and sometimes undesirable flavor of each seed. Additionally, blending the composite seed flour (5-100%) with grain flours (0%-95%),and/or tuber flours(0-95%), and/or sugar(0-%-50%), then further mitigates any overly strong seed flavors. Oil seed flour combined with grain flour or tuber flour, creates a product at parity with wheat based products for taste and texture, and a nutritional profile that significantly exceeds any grain or gluten free flour product formula.

The embodiment of this invention also applies to singular seed meals or flours, as some application maybe focused on optimizing the unique functional aspects of the seed, depending on nutrition, taste, production or cost requirements. For example, sunflower seeds maybe used exclusively in a waffle or pancake formula, with a ratio of 25-100% sunflower seed flour to 0-75% grain or tuber flour, as sunflower seeds have the mildest flavor, the most acceptable color for a seed flour, are highest in protein of all seeds and nuts, and are the most economical.

Seed flours are also considered to be made singularly of one flour type or are compositions of fully fatted seed flour or meal, defatted seed flour or meal, and/or seed protein isolates or concentrates. Various composition formulas will use full fat seed flours, defatted seed flours, and seed protein isolates singularly or in combination to achieve desired nutritional targets for a product.

The embodiment of this invention also applies to nut meals or flours for formula compositions. Depending on the application, almonds, cashews, hazelnuts, pistachios and peanuts can be converted into flours or meals and used in similar ratios defined herein for seeds to grain or tuber flours, with nuts being used from (25-100%) and grain or tuber flours being used from (0-75%). Nuts are also high in protein and have their own unique nutritional benefits. However, nuts often have a higher inflammation index than seeds, are more expensive, as well as exclude populations with nut allergies. Nut flours can be used in a composite blend or singularly.

The embodiment of this invention also applies to the use of legume flours for composition formulas to enhance protein content. Legumes are much higher in carbohydrates than seeds or nuts, and often impart an after taste in baked goods.

The embodiment of this invention applies to the use of seed or nut protein isolates and concentrates to enhance the protein value of food as well. This includes pumpkin seed protein isolates or concentrates (Omega Nutrition), Hemp Seed protein powder, Sunflower protein powder, flax an chia protein powder. Additionally, peanut and nut protein isolates or concentrates may be used. Since protein isolates have an undesirable taste, they are used in smaller concentrations (1-33%) of total formula, blended with either seed or nut composition flours, single seed flours, or grain and tuber flours to offset strong taste and provide proper product structure.

Although oil seeds(sunflower, pumpkin, chia, flax, hemp) provide a greater nutritional value than their grain and tuber counterparts, their high oil content make them difficult to transform into flour or meal without them turning into a paste. In the last few years, chia seed and flax seed have been converted to seed meals but their hydrophilic nature and bitter taste limits the volume that can be incorporated into processed food. They could not be singularly used in the optimum proportions of 33-100% of the total product, without imparting an undesirable flavor or gummy texture.

Sunflower and pumpkin seeds are the mildest flavor of all the seeds, and tend to work best as a majority of the volume of a food product. The higher the ratio of seed flour to grain/tuber flour, the greater the nutritional value. Sunflower and pumpkin seeds are the only seed that when milled correctly, can be used as a majority proportion of food product and still meet taste requirements. Because of manufacturing challenges, sunflower seed meal and pumpkin seed meal or flour are not readily accessible as food source.

The embodiment of this invention provides a process for converting sunflower and pumpkin seeds into a meal or flour. The two big problems with using sunflower or pumpkin seeds is the degree to which they can have a strong or bitter taste, and the rate at which they become rancid due to their high oil content. These problems are exacerbated when the seeds are milled, as the protective coating of the seed is ruptured and more surface space is exposed to air. In this invention, these problems are overcome by seed type choice, unique milling processes, and packaging.

One solution to overcoming taste and rancidity issues with sunflower seeds is choosing a seed that has been developed to retard rancidity and milder flavors. SunOpta has developed a hybrid sunflower seed, the SL80, which has an extended shelf life (SL) due to the type of oil in the seed. The standard sunflower seed's oil content is a 70-80% polyunsaturated fat, which goes rancid in 3-8 months depending on oxidative accelerants like oxygen and temperature. The SL80 is 80% high oleic, monounsaturated fat, which has a shelf life five times longer than traditional sunflower seeds. In addition, the flavor of the SL 80 sunflower seed, is much milder than traditional sunflower seeds, allowing it be used more liberally as a flour replacement in food products. Additionally, the SL80 sunflower seed seems to interact with leavening products to produce a lighter, fluffier batter, compared to traditional sunflower seeds. However other seeds, sunflower or pumpkin can work, as long as they are tested for flavor mildness and freshness, prior to converting to flour.

A second solution for transforming sunflower and pumpkin seeds into a flour or meal is related to the type and process of milling. Conventional milling equipment, such as roller mills, tend to turn the seed into paste, rather than a flour or meal, hence clogging the equipment. There are alternative micro milling processes that overcome problems of conventional, high volume, high friction mills. Nature's Chemistry has a genomic micro mill that has been able to convert the seeds into an acceptable sunflower and pumpkin seed flour for products. Also the IMD8 mill, by Machine Processing Equipment, can mill the seeds by using a mill that shreds the seeds with counter shredding blades, therefore not gumming up like traditional mills. Pin mills with an integrated cooling system can also convert seeds into an acceptable seed meal. All of the aforementioned mills, reduce the seeds to fractured seed particles of approximately 20-40 mesh size, forming a fine meal. This process leaves the seeds with their full healthy fat content and provide an small enough particle size that it can readily be converted into food product.

A third solution for milling sunflower and pumpkin seeds, as well as other oil seeds like flax, chia and hemp, is to defat the seeds by using a conventional cold processing extrusion press, or a conventional supercritical cooling process, removing 30-95% of oil. The remaining dry seed matter can then be milled with conventional milling equipment, e.g., micro milled from 20-100 mesh for food applications. The result is a fine flour with a lower calorie count than the full fat oil seed flour or meal. The protein content is also higher as the volume is more seed meat and less oil. Additionally the seed flour is now hydrophilic and requires more water for baking or product preparation purposes. Because it has a higher protein content per gram, than the full fat seed meal, it can be used in a lesser portion in the final composition. This is critical as it also has a stronger taste than the full fat seed flour. Some seed flour compositions are a combination of both fatted and defatted seed flours, depending on the protein profile required and the product type. Products with strong flavor profiles, like a chocolate brownie can tolerate stronger tasting seed flours, than a lightly baked waffle, and therefore will tolerate a higher proportion of defatted seed flour. The defatted seed milling process can also be applied to nuts.

A fourth solution to aid in the milling of the seeds is to expose the seeds to low temperature heat to dry or dehydrate the seeds or freeze them to remove moisture. Seeds are 8-10% moisture and the removal of liquid makes them more brittle and easier to break up in small particles during the milling process.

A fifth solution involves packaging processes. Exposure to air and temperature are proven to accelerate the rancidity of seed products. The final seed flours should be kept in a nitrogen flushed, foil lined, package and be kept in cold storage to retard rancidity, making the seed flours more commercially viable.

One of the more significant discoveries that embodies this invention is finding the optimum ratio of seed or nut flour to grain and tuber flour that balances flavor, texture and nutritional requirements. The optimal blend of seed flour to grain/tuber flour, creates a food product with taste and texture profiles that are at parity with wheat products, and deliver an ideal nutritional value for meeting recommended daily allowances for protein, fiber and whole grains.

The optimal formula for this invention, consists of 2 parts seed or nut flour to 1 part grain or tuber flour. The 2:1 ratio maximizes protein, balances the protein to carbohydrate ratio for improved blood sugar metabolism, and provides a favorable flavor and texture. For gluten free products, the additional protein and structure of the seed meal and flours, leads to a better baked good, as it provides a protein substitute for the gliadin protein in wheat based products. The 2:1 seed flour ratio tends to meet the nutritional targets of 10-30 grams for a baked good and yields a balanced ratio of 1-2 carbohydrate to 1 protein.

Although the ratio of 2:1 seeds to flour optimizes nutrition, baking and food development properties, the ratio has a wide variance, depending on prioritization of nutrition, taste, and product form factors. For traditional baked goods, like waffles, pancakes, scones, muffins, that would work as meal replacements, the 2:1 seed to flour ratio works perfect and delivers from 10-30 grams of protein. For commercial products that require a lower fat content, defatted seed flour or seed protein isolates can be used. Defatted seed flours tend to work better at 1:1 ratio for seed flour to grain or tuber flour, due to their higher concentration of protein per gram as well as their hydrophilic nature and stronger taste.

For the embodiment of this invention, protein is monotonically correlated to the amount of seed flour used in a recipe, and inversely correlated with lightness or fluffiness of a product. If more protein is desired in product, seed or nut flour can go up to 100% seed or nut flour with 0% grain or tuber flour, although there are some texture and taste acceptance decrements compared to traditional flours as the seed and nut flours reach 100%. The seed or nut flour can go down to 1% compared to traditional flours, but protein and nutritional values will be negated. When seed or nut flour is decreased it is exchanged for an equal weight of grain or tuber flour. Recipe formulas are provided to illustrate optimal seed/nut flour to grain/tuber flour compositions, and show the variance in composition ratios by product application.

Grain flours refer to, but are not limited to: Wheat, rye, barley, rice, sorghum, teff, kamut, millet, quinoa, corn flour and starch, amaranth

Tuber flours refer to, but are not limited to, tapioca, manioc, potato starch and flour, sweet potato starch or flour, arrowroot.

Resistant and modified starches from corn, tapioca, rice and potato are also used.

This invention uses a 2:1 ratio of flour to starch, when starch or tuber flour is used.

Fruit flours such as plantain maybe also be used.

This invention requires a binding system which can be accomplished with, but are not limited to, eggs, egg whites, egg replacers, gelled chia or flax seeds, xanthum, guar, pectin, gelatin, lecithins and agar agar.

Sweeteners like sugar, honey, agave, monkfruit, applesauce, fruit juice, stevia, fruit, sugar alcohols, etc, can be added to improve taste.

Fiber is added when additional sources of fiber are necessary to meet nutritional targets. Inulin, nopal, pea fiber, fruit fiber and resistant starch are used to increase fiber content.

Protein isolates are added, when additional sources of protein are necessary enhancing protein levels and reducing calories. Protein isolates or concentrates are used from oil seeds, eggs, but may also incorporate whey and soy.

Fat is used in the form of oil or butter to improve moisture and tenderize some products.

Milk, water, other liquids, pastes or purees are used to impart moisture.

Flavor systems are used for enhancing or masking the seed flour taste to improve consumer acceptability. Flavors include, but are not limited to, vanilla, cinnamon, nutmeg, lemon, orange, buttermilk, etc.

Composition formulas are given to illustrate the broad product application of this concept and illustrate the seed to traditional flour optimal ratio of 2:1. Additional composition formulas are given to illustrate the ranges in the 2:1 ratio that can be achieved to maximize protein and nutrition, and still maintain consumer acceptability for taste and texture. Some recipes illustrated here show the broad range of seed to traditional flour blends that can be achieved, with the seed flour to grain or tuber flour being as high 9:1 or as low as 1:9, depending on product objectives. Recipes are predominantly gluten free and nut free to allow for the widest range of consumer accessibility. However, wheat flour and nut flours can be used interchangeably. Grain flours can be replaced with tuber flours in some recipes for grain free versions, acceptable to those on a Paleo diet.

### EXAMPLES

### Waffle Recipe—Grain Free (10-15 Grams of Protein)/1 Protein:2 Carbohydrates

40 grams (g)-60 g Sunflower Seeds (Defatted flour or seed meal)

11 g Sweet Potato Flour (7 g light +4 g dark)

10 g Starch (7 g potato; 3 g Tapioca)

10 g Baking Powder

12 g Sugar

1.5 g Salt

1 large egg

1 tablespoon (tbs) milk

1 tbs oil

½ teaspoon (tsp) Vanilla extract

### Pancake Recipe—Grain Free (10-15 Grams of Protein)

40 g Sunflower Seeds (Defatted flour or seed meal)

11 g Sweet Potato Flour (7 g light +4 g dark)

10 g Starch (7 g potato; 3 g Tapioca)

10 g Baking Powder

12 g Sugar

1.5 g Salt

1 large egg

3 tbs milk

1 tbs oil

½ A teaspoon (tsp) Vanilla extract

### Gourmet Waffle Recipe—Low Protein/High Gourmet Taste (1:4 Seed Flour to Traditional GF Flour)

10 g Sunflower seed meal or flour

7.5 g Sorghum

2.5 g Potato Flour

12.5 g Sweet Rice Flour

7.5 g Potato Starch

5 g Arrowroot starch

5 g Cornstarch

1 tsp Baking Powder

⅛ tsp Salt

1 egg

1 tsp Maple syrup

2 tbs butter

¼ A cup (c) Milk

¼ tsp vanilla extract

### Waffle & Pancake Mix Replacement Recipe (Extra High Protein: 20-30 Grams)

(The 2:1 Seed flour to grain/tuber flour also substitutes in available pancake and waffle mix)

2 c Seed Flour

1 c Waffle or Pancake mix (Bob's Namaste, King Arthur, et)

1 tbs Baking Powder

6 eggs

⅞ c Milk

6 tbs oil

20 gm Protein Waffle

Namaste+Seed Flours

p145 20 gm protein waffle

3 Namaste:2 Seed Flour

### Dry Ingredients

3 tbs Namaste

2 tbs seed flour

(1 tbs PSPowder)/Omega Nutrition

(1 tbs SFS Powder)/Defatted

¼ tsp baking powder

cinnamon

### Wet Ingredients

1 egg (large cage free)

2 tbs Milk

1 tsp grape seed oil

1 tsp Maple syrup

¼ tsp Vanilla

Makes (1) 4.5″ square waffle in a

Westinghouse Waffle Iron

### 25 G Protein Waffle Recipe

25 G Protein!(p)

Namaste 4:3 Seed Flour

Namaste ¼ c

PSF 1.5 tbs Omega

SSF 1.5 tbs Defatted

½ tsp Baking powder

Dry Total

1 Large Cage Free egg (medium)

3/16 c milk

2 tsp Grape Oil→1 tsp

1 tsp Maple syrup

¼ tsp Vanilla

Yield=(1) 4.5″ square

### Muffin Recipe—Starch Free (12-15 Grams Protein)

1 Large Egg

70 g Sunflower Seed Flour (Seed Meal or Defatted)

26 g Sorghum (Sweet white)

1 tsp Double Acting Baking Powder

3 tbs Organic Cane Sugar.

1 tsp Vanilla

¼ tsp Salt

1 tsp Cinnamon

1 tsp Oil or Melted Butter

36 g Milk or Water (try each way and see if you have a preference)

⅔ c finely diced apples (with or without skins)

½ tsp Vinegar or Lemon Juice

### Streusel Topping

25 g Sunflower Seed Flour

11 g Sorghum

2 tbs White Cane Sugar

½ tsp Cinnamon

Pinch Salt

1½ tbs oil or melted butter.

### Vegan (Egg Free) Recipe

70 g Sunflower Seed Flour

26 g Sorghum

1¼ tsp Double Acting Baking Powder

3 tbs Organic Cane Sugar

1 tsp Vanilla

¼ tsp Salt

1 tsp Cinnamon

1 tsp Oil or Melted Butter

36 g Milk or Water

⅔ c Diced Apples

½ tsp Vinegar

### Streusel

13 g Sunflower Seed Flour

6 g Sorghum

1 tbs Cane Sugar

¼ tsp Cinnamon

pinch salt

½ tbs oil or melted butter

Bake at 350 degrees Fahrenheit for 25 minutes

### Lemon Poppy Seed Version

Add 1 tbs of Poppy seeds and 1 tsp of Lemon extract to above recipes

### Muffin Recipe With Starch

135 g Seed Meal

42 g sorghum flour

21 g starch (14 g potato+7 g tapioca starch)

42 g sugar

14 g baking powder

¼ tsp salt

⅜ tsp Xanthum gum

⅓ c blueberries

2 eggs

2 tbs butter

⅜ c milk

½ tsp vanilla

Bake at 400 degrees Fahrenheit for 20 min

### Muffin Recipe—Starch Free (15-18 Grams Protein)

1 Large Egg

60 g Sunflower Seed Flour (Seed Meal or Defatted)

10 g Protein powder (Pumpkin seed or instantized egg white)

26 g Sorghum (Sweet white)

1 tsp Double Acting Baking Powder

3 tbs Organic Cane Sugar.

1 tsp Vanilla

¼ tsp Salt

1 tsp Cinnamon

1 tsp Oil or Melted Butter

36 g Milk or Water (try each way and see if you have a preference

⅔ c finely diced apples (with or without skins)

½ tsp Vinegar or Lemon Juice

### Scone Recipe

135 g SeedMeal composite (50% sunflower seed flour/50% Pumpkin seed flour; defatted sunflower and pumpkin seed)

42 g Sorghum Flour (Dakota Prairie or Nulife Market)

21 g Starch (14 g potato starch/7 g Tapioca starch)

1 tbs Baking Powder

2 tbs Coconut Palm Sugar

⅛ tsp Salt

⅜ tsp Xanthum gum

2 eggs

2 tbs butter cut in until pea size

¼ c orange juice (or milk)

¼ tsp lemon juice

¼ tsp lemon zest (or 1/2 tsp vanilla extract)

⅓ c Dried cranberries or Fresh Blueberries

Bake at 400 degrees Fahrenheit for 25 min

### Breakfast Power Bar Recipe—Composite Flour—Super Protein (20+ grams Protein) Ratio 9:1 Seed Flour Composite to Flour/starch

1 c Sunflower and pumpkin seed flour

¼ c pumpkin seed protein powder

⅛ c Tapioca Flour

⅛ c Sorghum Flour

¼ c Chia Flour—Nuchia

½ tsp Balking Powder

¼ c Sunflower Seeds

¼ c Pumpkin Seeds

¼ c Peanut Butter

1-2 eggs

¼ c oats

3 tbs Honey

¼ c Chocolate Chips

¼ c Dried cranberries

¼ tsp Salt

¼ tsp Cinnamon

¼ tsp Vanilla

Bake at 350 degrees Fahrenheit for 20 min

### Brownie Recipe (Composite Seed Flour & Seed Protein Recipe) 8 Seed:2 Flour

¾ c sunflower, hemp, pumpkin seed meal or defatted meal

¼ c Pumpkin Seed Protein Powder (Omega Nutrition brand)

⅜ c Cocoa Powder (Wonder Cocoa)

⅛ c Arrow Root

½ tsp baking soda

⅛ tsp salt

⅓ c honey

⅙ c butter or oil

½ c Coconut milk

1 tsp Vanilla extract

1 egg+1 egg white

Bake at 350 degrees Fahrenheit for 35 minutes.

### Cookie Recipe

1 c Seed Meal(Pumpkin and Sunflower)

½ c Sorghum Flour

¼ c Tapioca Flour

1 tsp Baking Powder

½ tsp of Xanthum Gum

¼ tsp salt

⅓ c Grapeseed oil

⅓ c Coconut palm sugar

2 tbs Applesauce

1 tsp Vanilla

¼ c chocolate chips

Bake at 250 degrees Fahrenheit for 15 minutes

### High Protein Dairy Replacement (15 g Protein)

½ c sunflower and pumpkin seed meal (ratio—50/50)

1 c of filter “boiling” water (to aid in emulsification)

¼ tsp of vanilla

1 tsp honey

Blend in high speed vitamix mixer until thoroughly liquified. Let cool in refrigerator. Used to increase protein and micro nutrients for cereals. Just add to cereal for achieving 15 grams of protein at breakfast.

### High Protein/Low Carb Ice Cream Recipe

1 c of Cashews

1 c of water

¼ c of maple syrup

1 tablespoon of vanilla extract

Blend until liquified; cool in refrigerator. Put in conventional ice cream maker and turn until frozen.

### Chocolate Bark Recipe

1 c dark confectionary chocolate

1 c Seed Meal (pumpkins and sunflower seeds) (ratio 50/50)

¼ c sunflower and pumpkin seeds (ratio 50/50)

¼ c dried cranberries

¼ c of SunButter or Peanut Butter

Melt Chocolate on double pan; Add in other ingredients and stir until thoroughly mixed. Pour out on wax or parchment paper and spread to ¼-½ inch thick. Let cool.

### All Purpose Flour Recipe

2 c sunflower seed meal or flour

½ c sorghum flour

½ c Brown Rice Flour

¼ c Potato Starch

¼ c Tapioca Starch

### Commercial Mix replacement (Pancake, Muffin, Scone, Brownie, Cake)

2 part SUNFLOUR seed MEAL flour

1 part mix

+1 extra egg

+1 extra tbs oil

### Apple Cinnamon Coffee Cake

135 g SeedMeal composite (50% sunflower seed flour/50% Pumpkin seed flour

42 g Sorghum Flour (Dakota Prairie or Nulife Market)

21 g Starch (14 g potato starch/7 g Tapioca starch)

1 tbs Baking Powder

2 tbs Coconut Palm Sugar

⅛ tsp Salt

⅜ tsp Xanthum gum

2 eggs

2 tbs butter cut in until pea size

⅓ Cup milk

¼ tsp lemon juice

⅔ C Diced Apples

Streusel Topping

26 g Sunflower Seed Flour

12 g Sorghum

2 tbs Cane Sugar

½ tsp Cinnamon

pinch salt

1 tbs oil or melted butter

Bake at 350 degrees Fahrenheit for 25 min

### Chocolate Cake or CupCakes

135 g SeedMeal composite (50% sunflower seed flour/50% Pumpkin seed flour; defatted sunflower and pumpkin seed)

42 g Sorghum Flour (NuLife Market Dark Sorghum/Bran)

21 g Starch (14 g potato starch/7 g Tapioca starch)

¼ c of chocolate powder

1 tbs Baking Powder

4 tbs White Cane Sugar

⅛ tsp Salt

⅜ tsp Xanthum gum

2 eggs

2 tbs butter

⅓ Cup milk

¼ tsp lemon juice

Bake at 350 for 25 min

### Cracker Recipe (100% Seed Flour)

2 c of sunflower and pumpkin seed meal

1 c of flax meal

1 c of pumpkin seeds

1 c of sesame seeds

2 tsp of salt

3 tbs of grape seed oil

3 large eggs

Mix and roll out in ⅛″ thick dough on parchment paper

Cut into 2″ squares

Bake at 350 degrees Fahrenheit for 10-15 minutes

### Pizza Recipe

1 c Sunflower seed flour

½ c sorghum flour

¼ tsp salt

1 packet of yeast

¼ c of grapeseed oil

¼ c of water

Let yeast activate in 120 degrees Fahrenheit water for 10-15 minutes

Mix with other dry and wet ingredients and let sit in cover bowl for 1 hour

Roll out dough into 12 inch circle

Bake 10 minutes

Add desired toppings: Pesto, or tomato sauce, shredded mozarella cheese, tomatos, spinach, chicken or roasted vegetables (brussel sprouts, brocolli, potatos)

### Pasta Recipe

35 g sorghum flour (or other grain flour)

25 g Sunflower seed flour

20 g Cornstarch

20 g potato starch

¼ tsp salt

8 g flax seed meal

1 egg

50 g water

1 tbs of olive oil

Mix and roll into sheet. Run through pasta noodle press and make ¼ inch noodles.

Drop in boiling water until floating or tender.

### Bread Recipe

¼ c sunflower seed flour

¼ c White pearl sorghum flour

¾ c sunflower seed butter

2 tbs Olive oil

¼ c of arrowroot starch

½ tsp salt

½ tsp of baking soda

1 tbs sugar

3 large eggs

Mix and bake in bread pan at 350 degrees Fahrenheit for 25 minutes

### High Protein Soup

1 c of sunflower and pumpkin seed meal composite

3 c of boiling vegetable or chicken broth

1 tsp of salt

1 tsp of pepper

Blend until emulsified and creamy

Add:

¼ c onions

1 clove of garlic

½ c of carrots

½ c of sweet potato

Full bunch of kale

Simmer until vegetables are tender

Add pumpkin seeds for garnish;

### High Protein Donuts

27 g potato starch

18 g millet flour

37 g white rice flour

41 g sunflower seed meal

41 g pumpkin seed meal

¼ tsp Xanthum gum

1.5 tsp baking powder

¼ tsp salt

¼ c Sugar

1 large egg

2 tbs of melted butter or oil

80 g milk

Whisk ingredients together and spoon into a doughnut pan. Bake at 375 degrees Fahrenheit for 12-15 minutes. Let cool and then put icing or powder sugar on them.

### High Protein Pop Tart style pastry

1 c of ground pumpkin and sunflower seeds

1 tbs of poppy seeds or white chia seeds

¼ c of honey

1 tsp vanilla

Blend ingredients into a paste. Take pie crust dough and cut into 4 inch squares. Spread 3 tablespoons of seed paste onto (1) 4 inch square. Put second 4 inch square of dough on top and seal around edges, mashing with a fork. Bake at 350 degrees Fahrenheit for 15 minutes or until golden brown, then remove.

### High Protein Cereal Recipe

25% sunflower seed flour (defatted)

25% corn flour

10% corn starch

15% sugar

25% water

Mix into a slurry and use cereal extrusion press for making O's or puffs. Heat at 400 degrees Fahrenheit for 15-20 minutes until crisp and puffy.

### High Protein Chips

25% sunflower seed flour (defatted)

25% corn flour

10% corn starch

15% sugar

25% water

Mix into a slurry and use cereal extrusion press for making squares. Heat at 400 degrees Fahrenheit for 15-20 minutes until crisp and puffy.

### High Protein Meal Replacement Bars

½ c sunflower seeds, coarsely ground

½ c pumpkin seeds coarsely ground

¼ c chia seeds

¼ c dried fruit (cranberries or blueberries)

¼ c agave

Mix and bake at 300 degrees Fahrenheit for 20-30 minutes. Let cool and cut into squares.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1.-21. (canceled)

22. A composite flour composition comprising
from 5 to 100 wt. % oil seed flour,
from 0 to 95 wt. % nut flour,
from 0 to 67 wt. % wheat flour, and
from 0 to 67 wt. % gluten free flour;
wherein oil seeds in the oil seed flour are selected from the group consisting of sunflower seeds, pumpkin seeds, chia seeds, flax seeds, hemp seeds, and combinations thereof and
wherein nuts in the nut flour are selected from the group consisting of almonds, cashews, hazelnuts, pistachios, peanuts and combinations thereof.

23. The composite flour composition according to claim 22, wherein the oil seed is sunflower seed, pumpkin seed or a combination thereof

24. The composite flour composition according to claim 22, wherein the oil seed in the oil seed flour is sunflower seed.

25. The composite flour composition according to claim 24, wherein the sunflower seed comprises about 80% oleic acid and has a shelf-life of at least 15 months.

26. The composite flour composition according to claim 22, wherein the oil seed in the oil seed flour is pumpkin seed.

27. The composite flour composition according to claim 22, further comprising from a non-zero amount to 95 wt. % tuber flour; and
wherein the tubers in the tuber flour are selected from the group consisting of tapioca, manioc, potato, sweet potato, arrowroot and combinations thereof

28. The composite flour composition according to claim 22, further comprising from a non-zero amount to 95 wt. % legume flour; and
wherein the legume in the legume flour is selected from the group consisting of alfalfa, clover, peas, beans, lentils, lupins, mesquite, carob, soy, and any combination thereof

29. The composite flour composition according to claim 22, further comprising from a non-zero amount to 95 wt. % grain flour; and
wherein the grain in the grain flour is selected from the group consisting of wheat, rye, barley, rice, sorghum, teff, kamut, millet, quinoa, corn, starch, amaranth, and combinations thereof.

30. The composite flour composition according to claim 22, wherein the protein to carbohydrate ratio is from about 1:1 to 1:2, and
wherein the composite flour has a complete amino acid profile.

31. A method for preparing the composite flour of claim 22, the method comprising
providing whole oil seeds;
processing the oil seeds thereby making a flour that comprises oil seeds; and optionally
blending the nut flour, wheat flour and/or gluten free flour with the flour that comprises oils seeds thereby preparing a composite flour.

32. The method according to claim 31, wherein processing the oil seed uses micromilling.

33. The method according to claim 31, wherein processing the oil seed uses a counter shredding technique.

34. The method according to claim 31, the method further comprising
defatting the oil seed and/or nuts prior to processing the oil seeds via a cold extrusion press, a supercritical cooling process or a combination thereof.

35. The method according to claim 34, wherein defatting removes from 50 to 95 wt. % of the fat.

36. The method according to claim 34, wherein defatting is done via a cold extrusion press.

37. The method according to claim 34, wherein defatting is done via a supercritical cooling process.

38. The method according to claim 31, wherein the prepared flour is from about 20 to about 100 mesh.

39. The method according to claim 31, wherein the oilseed is sunflower seed.

40. The composite flour composition according to claim 39, wherein the sunflower seed comprises about 80% oleic acid and has a shelf-life of at least 15 months.

41. The method according to claim 31, wherein the oilseed is pumpkin seed.
